(19) United States
(12) Patent Application Publication
(10) Pub. No.: US 2025/0180490 A1
(43) Pub. Date: Jun. 5, 2025

(54) ANALYSIS METHOD

(71) Applicant: CANON KABUSHIKI KAISHA, Tokyo (JP)

(72) Inventors: MAKOTO KAWAGUCHI, Kanagawa (JP); YUKI YONETANI, Kanagawa (JP); SHIGERU ICHIHARA, Tokyo (JP)

(21) Appl. No.: 19/048,748

(22) Filed: Feb. 7, 2025

Related U.S. Application Data
(63) Continuation of application No. PCT/JP2023/026495, filed on Jul. 20, 2023.

(30) Foreign Application Priority Data
Aug. 9, 2022 (JP) 2022-127217

(51) Int. Cl. G01N 21/95; G01N 21/64; G01N 21/65

(52) U.S. Cl. CPC G01N 21/95; G01N 21/6402; G01N 21/65

(57) ABSTRACT

An analysis method includes acquiring first information concerning the optical density of the functional group based on a first fluorescence spectrum measured by irradiating a predetermined region of the sample with first light, acquiring second information concerning the optical density based on a second fluorescence spectrum measured by irradiating at least a part of the predetermined region with second light after the irradiation of the first light, and acquiring third information concerning degradation of the sample based on the first information and the second information.

### CROSS-REFERENCE TO RELATED APPLICATIONS

This application is a Continuation of International Patent Application No. PCT/JP2023/026495, filed Jul. 20, 2023, which claims the benefit of Japanese Patent Application No. 2022-127217, filed Aug. 9, 2022, both of which are hereby incorporated by reference herein in their entirety.

### BACKGROUND OF THE INVENTION

### Field of the Invention

The present invention relates to an analysis method for acquiring information about degradation of resins contained in collected products, collected components, and the like.

### Background Art

Waste reduction resulting from increased reuse rate of collected components by identifying components that can be reused after products are collected or by identifying components that can be reused as recycled components by recovery processing is known. For the possibility of reuse, a method of acquiring an index indicating a degree of degradation of a constituent material in a non-destructive test by a spectral identification apparatus is employed instead of an irreversible destructive test, such as a strength test. PTL 1 and PTL 2 discuss a technique for estimating a degree of degradation of resins by an identification apparatus using Raman scattered light.

PTL 1 discusses a spectral identification apparatus that evaluates a degree of degradation of resins forming a sealing member of a solar cell module based on a dichroic ratio of a fluorescence intensity of an alkane structure to a fluorescence intensity of an ester structure. The alkane structure and the ester structure are included in an optical spectrum acquired as secondary light. PTL 1 discusses an analysis technique for evaluating the degree of degradation at a travel distance from an irradiation spot of primary light for focus adjustment, thereby reducing effects of fluorescence photobleaching due to the focus adjustment.

PTL 2 discusses a spectral identification apparatus for evaluating the degree of degradation of a protective resin coated on a cable by comparing the fluorescence peak intensity of a standard specimen with the fluorescence peak intensity of a measurement specimen. PTL 2 discusses the analysis technique in which a wavelength of primary light that is shifted from a wavelength at which fluorescence components are generated at high efficiency is used to reduce effects of fluorescence photobleaching.

### CITATION LIST

### Patent Literature

PTL 1: Japanese Patent Application Laid-Open No. 2020-195182
PTL 2: Japanese Patent Application Laid-Open No. H07-260688

Fluorescence components acquired by the spectral identification apparatus include components derived from functional groups in which fluorescence photobleaching occurs due to irradiation of primary light used for measurement, which makes it difficult to separate functional groups generated due to effects of the measurement from functional groups generated due to degradation over time before the measurement. Therefore, there is a concern that the degree of degradation of resins cannot be accurately evaluated.

Since the technique discussed in PTL 1 uses the moving of the irradiation spot of primary light as a countermeasure against bleaching, there is a need to use preliminary information indicating whether the uniformity of the material in other irradiation areas including the moving range is ensured. Since PTL 2 employs a primary light wavelength search for each sample as a countermeasure against bleaching, there has been a concern that it is difficult to predict the time and man-hour required for the search. Accordingly, there has been a demand for an evaluation technique for simply acquiring information concerning the degradation of resins without the need for preliminary information concerning the uniformity of a sample and the selection of a wavelength.

### SUMMARY OF THE INVENTION

The present invention is directed to providing an analysis method for simply acquiring information concerning the degradation of resins by reducing effects of photobleaching resulting from a spectral measurement.

According to an aspect of the present invention, an analysis method for acquiring information about degradation of a sample including a resin using information concerning an optical density of a functional group contained in the resin includes acquiring first information concerning the optical density of the functional group based on a first fluorescence spectrum measured by irradiating a predetermined region of the sample with first light, acquiring second information concerning the optical density based on a second fluorescence spectrum measured by irradiating at least a part of the predetermined region with second light after the irradiation of the first light, and acquiring third information concerning degradation of the sample based on the first information and the second information.

Further features of the present invention will become apparent from the following description of exemplary embodiments with reference to the attached drawings.

### BRIEF DESCRIPTION OF THE DRAWINGS

FIG. 1 is a flowchart illustrating steps of an analysis method according to a first exemplary embodiment.

FIG. 2A is a diagram illustrating a first identification apparatus that executes the analysis method according to the first exemplary embodiment.

FIG. 2B is a diagram illustrating projection of a spectral image on an imaging unit according to the first exemplary embodiment.

FIG. 3A is a schematic configuration diagram illustrating operations of steps S100 and S200 of the analysis method according to the first exemplary embodiment.

FIG. 3B is a schematic configuration diagram illustrating operations of steps S100 and S200 of the analysis method according to the first exemplary embodiment.

FIG. 4 is a graph of intensities of primary light and fluorescence over time in steps S100 and S200 of the analysis method according to the first exemplary embodiment.

FIG. 5 is a flowchart illustrating steps of an analysis method according to a second exemplary embodiment.

FIG. 6A is a schematic configuration diagram illustrating an operation of a second identification apparatus that executes the analysis method according to the second exemplary embodiment.

FIG. 6B is a schematic configuration diagram illustrating an operation of the second identification apparatus that executes the analysis method according to the second exemplary embodiment.

FIG. 7 is a graph of intensities of primary light and fluorescence over time in each step according to the second exemplary embodiment.

FIG. 8 is a flowchart illustrating steps of an analysis method according to a third exemplary embodiment.

FIG. 9 is a graph of intensities of primary light and fluorescence over time in each step according to the third exemplary embodiment.

FIG. 10A is a flowchart illustrating steps of an analysis method according to a fourth exemplary embodiment.

FIG. 10B illustrates a determination example in a step of acquiring preliminary information concerning degradation according to the fourth exemplary embodiment.

### DESCRIPTION OF THE EMBODIMENTS

Preferred exemplary embodiments of the present invention will be described in detail below with reference to the drawings.

### First Exemplary Embodiment

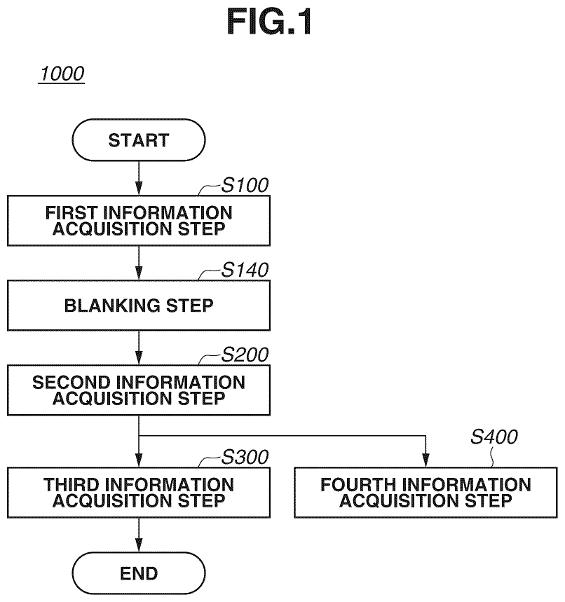

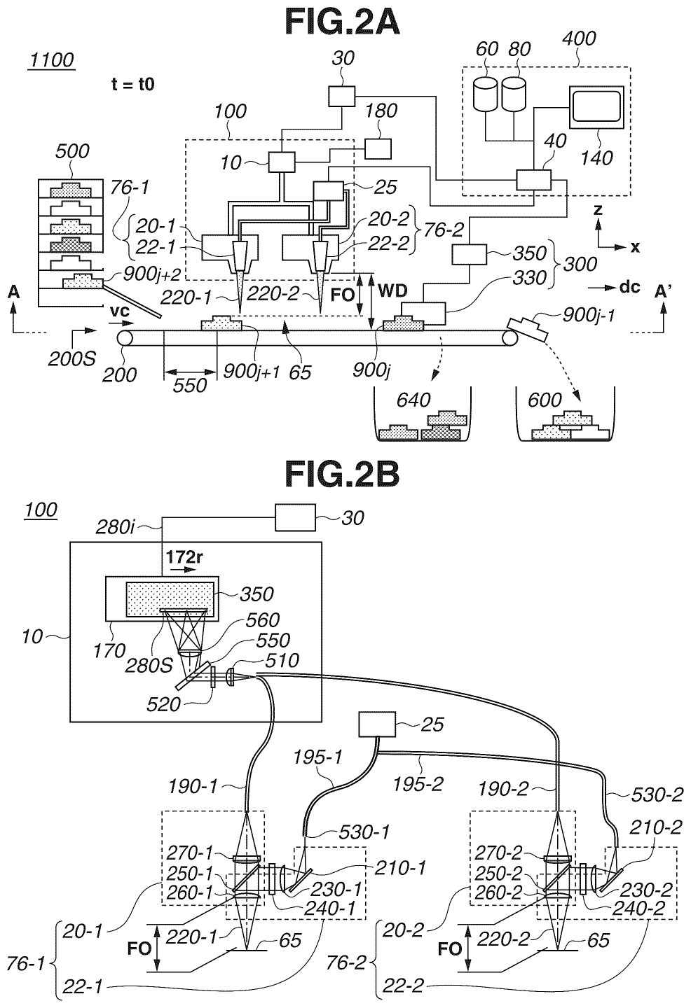

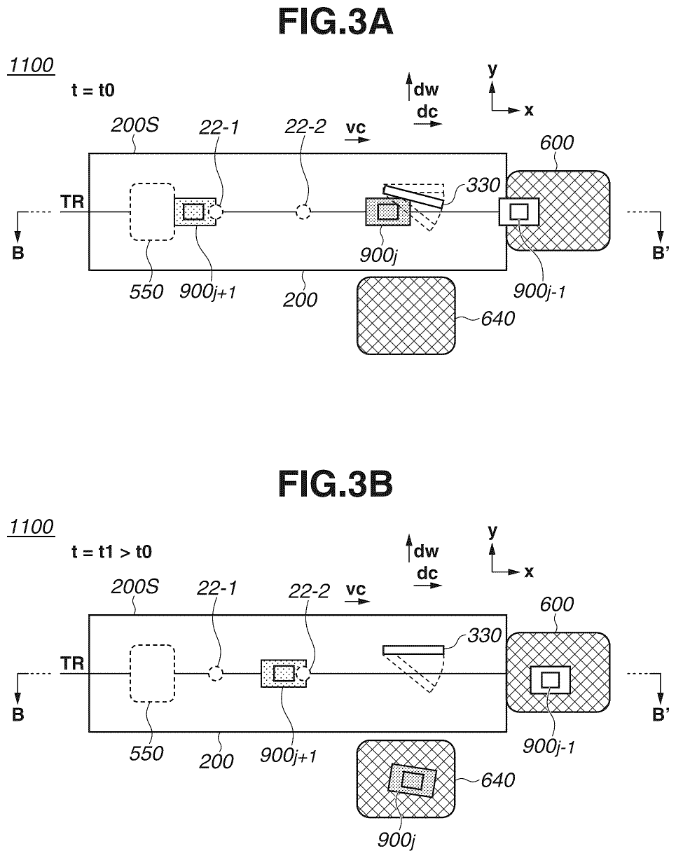

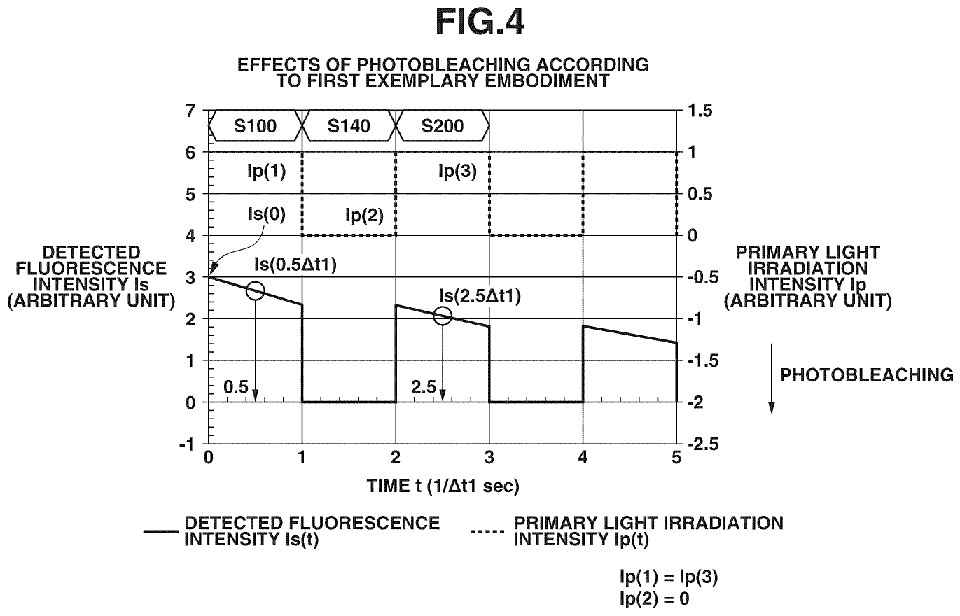

An analysis method 1000 according to a first exemplary embodiment will be described with reference to FIGS. 1, 2A, 2B, 3A, 3B, and 4. FIG. 1 is a flowchart illustrating steps of the analysis method 1000 according to the first exemplary embodiment and the order of steps. FIG. 2A illustrates a schematic configuration of a first identification apparatus 1100 that executes the analysis method 1000 according to the first exemplary embodiment, and FIG. 2B illustrates a schematic configuration of a spectral information acquisition unit 100. FIGS. 3A and 3B each illustrate an operation of the identification apparatus 1100 according to the first exemplary embodiment. FIG. 4 is a graph of an irradiation intensity Ip(t) of primary light and a detected intensity Is(t) of a fluorescence component over time in each step according to the first exemplary embodiment.

### (Resin Degradation Mode)

Information acquired by the analysis method 1000 according to the first exemplary embodiment is information concerning the degradation of a resin sample. A resin degradation mode will be briefly described.

The first exemplary embodiment uses a resin degradation model in which degradation proceeds due to a structural change in which functional groups are generated when a main skeleton is separated. As a mathematical interpretation, the degradation of resins is dependent on the amount (remaining amount) of the resin skeleton with no degradation when no functional groups are generated, and is based on General Equations (1) and (2) that are degradation models that describe a degradation behavior per unit time.

Equation (1) is a differential equation corresponding to the above-described degradation model, and Equation (2) is a general solution that is unambiguously derived from Equation (1). In Equations (1) and (2), t represents an elapsed time td after production of resins in which degradation proceeds depending on an environmental load such as water, heat, gas, light, and stress. A molecular weight corresponding to the amount of the resin skeleton present at time td is also referred to as the remaining amount of the resin skeleton. Further, Td represents a degradation time constant that is a degradation parameter for describing the degradation of the resin skeleton over time at a molecular weight V(t).

$$- Δ V ( {t}_{d} ) / V ( t ) = {c}_{0} Δ {t}_{d} \\ In ( V ( {t}_{d} ) ) = - {c}_{0} {t}_{d} + {c}_{1} \\ {c}_{0} = 1 / {τ}_{d , c 1} = In ( V ( 0 ) ) \qquad ( 1 )$$

$$V ( t ) = V ( 0 ) \times exp ( - {t}_{d} / {τ}_{d} ) \qquad ( 2 )$$

Target information to be originally acquired in the present invention is information concerning the degradation of a resin sample. This information corresponds to a difference V(0)−V(t) between an initial resin skeleton amount and a resin skeleton amount remaining immediately before measurement. In(P) represents the natural logarithm of a numerical value P of a base e.

In general, the remaining resin skeleton amount V(t), the initial resin skeleton amount V(0), the degradation time constant τd, and the elapsed time td of collected components for which history of an environmental load is uncertain are unknown. However, information regarding an optical density of functional groups that present fluorescence corresponding to the difference V(0)−V(t) between the initial resin skeleton amount and the remaining resin skeleton amount can be optically acquired from intensity information about fluorescence components in a silent region of a Raman scattering spectrum. The analysis method 1000 according to the first exemplary embodiment basically uses the above-described technique.

An optical spectrum including Raman scattered light includes Raman scattered light components corresponding to a molecular binding that forms a sample 900i, Rayleigh scattered light components that are elastically scattered on the surface of the sample 900i and do not include information about the molecular binding, and fluorescence components that are generated in the process of deactivating energy of absorbed light. In the acquired optical spectrum, the Raman scattered light components are not observed continuously and uniformly with respect to a wavenumber shift, but are observed in a specific band called a fingerprint region, or a CH or OH stretching vibration region, at the lower side and the higher side of the wavenumber shift. A wavenumber band of 1800 cm ⁻¹ to 2700 cm⁻¹ between a fingerprint region and a stretching vibration region is called a silent region. In the silent region, a Raman scattered light peak is not significantly observed.

The optical spectrum observed in the silent region is deemed to be fluorescence components derived from functional groups that are discretely contained in a resin sample. The analysis method 1000 according to the first exemplary embodiment uses the intensity Is(t) of fluorescence components detected in the silent region as an index to provide information V(0)−V(t) about the optical density of functional groups generated due to the degradation of resins in the sample 900i.

In the case of polypropylene (PP), polyethylene (PE), polycarbonate (PC), and polystyrene (PS), the intensity of a fluorescence signal with a band width of 50 to 900 cm⁻¹ selected from 1800 cm⁻¹ to 2700 cm⁻¹ is used as an index for fluorescence components derived from functional groups generated due to the degradation of resins.

### (Effects of Fluorescence Photobleaching due to Spectral Identification)

A spectral identification apparatus using Raman scattered light uses primary light of focused laser light to irradiate a sample with because the detected intensity of Raman scattered light components is extremely low, specifically, in the order of 10⁻⁵ to 10⁻⁶, with respect to the irradiation intensity of primary light. A spectral identification method using Raman scattered light uses the optical density of functional groups that present fluorescence light emission in the resin sample as an index, while the fluorescence characteristics of the functional groups are subjected to photobleaching that is irreversibly deactivated due to the irradiation of the primary light.

Accordingly, there is a probability that the intensity of fluorescence components from the resin sample irradiated with the primary light by a Raman spectral identification apparatus can include effects of fluorescence photobleaching caused due to the irradiation of the primary light. Therefore, in order to accurately evaluate the degradation of resins, it may be desirable to acquire information concerning the optical density of functional groups that present fluorescence present in the sample from which effects of photobleaching are separated, that is, immediately before a measurement is performed on the sample.

### (Separation of Fluorescence Photobleaching)

Next, the analysis method 1000 for acquiring third information regarding the degradation of the resin sample from which effects of fluorescence photobleaching are separated will be described with reference to FIGS. 1, 2A, 2B, 3A, and 3B.

As illustrated in FIG. 1, the analysis method 1000 according to the first exemplary embodiment includes step S100 of acquiring first information concerning the optical density of a predetermined functional group contained in the sample based on a first fluorescence spectrum measured by irradiating a predetermined region of the sample with first light. The analysis method 1000 further includes step S200 of acquiring second information concerning the optical density based on a second fluorescence spectrum measured by irradiating at least a part of the predetermined region with second light after the irradiation of the first light. The analysis method 1000 further includes step S300 of acquiring third information concerning the degradation of the sample based on the first information and the second information. The third information also includes information corresponding to the resin degradation state immediately before the spectral measurement from which effects of photobleaching by the first light and the second light irradiated to acquire the first information and the second information, respectively, are separated. A schematic configuration diagram of the identification apparatus 1100 illustrated in FIG. 2A corresponds to a plane taken along B-B′ in FIGS. 3A and 3B, and a schematic configuration diagram of the identification apparatus 1100 illustrated in FIGS. 3A and 3B corresponds to a plane taken along A-A′ in FIG. 2A.

The identification apparatus 1100 is a Raman scattering identification apparatus configured to collect Raman scattered light from the sample 900i as secondary light and to acquire an optical spectrum as one-dimensional spectral image information Is using a spectral identification unit 10 including a spectral element 550 and an imaging unit 170.

The identification apparatus 1100 includes an acquisition unit 30 for acquiring material information concerning the degradation of a material contained in the sample 900i based on the acquired one-dimensional spectral image information, and a command unit 40 for issuing a command indicating a discrimination operation to a discrimination apparatus 300 based on information from the acquisition unit 30. The discrimination apparatus 300 discriminates a plurality of samples 900i identified based on the degree of degradation into a sample group that can be reused and a sample group that cannot be reused based on a discrimination command from the command unit 40.

Table 1 illustrates a list of relationships between a bleaching attenuation ratio and irradiation conditions for primary light in the first information acquisition step S100 and the second information acquisition step S200 of the analysis method 1000 according to the first exemplary embodiment. A bleaching attenuation ratio D(t) is an index corresponding to the degree of effect of fluorescence photobleaching at time t.

The present application uses functional groups that present fluorescence as a structure serving as an index for degradation of resins, and the functional groups may otherwise be referred to as fluorescent groups.

TABLE 1

| | | Change of | |
|---|---|---|---|
| | | Fluorescence | |
| | Primary | Intensity | Optically- |
| | Light | over Time | Acquired |
| | Irradiation | in Each Step | Bleaching |
| Step | Intensity | Fluorescence | Attenuation |
| Time | Ip(t) | Intensity Is(t) | Ratio D |
| S100 | Ip(1) | Is(0) × exp(−t/τ) | exp(−0.5Δt1/τ) |
| 0 ≤ t < Δt1 | | | |
| S140 | 0 | 0 | 0 |
| Δt1 ≤ t < 2Δt1 | | | |
| S200 | Ip(1) | Is(0) × exp(−Δt1/τ) × | exp(−1.5Δt1/τ) |
| 2Δt1 ≤ t < 3Δt1 | | exp(−(t − 2Δt1/τ) | |

In the first information acquisition step S100 according to the first exemplary embodiment, first information Is(0.5Δt1) acquired from the fluorescence intensity and a fluorescence intensity Is(0) corresponding to a non-irradiation state are algebraically described, so that Equation (3) is derived.

In Equation (3), Is(0), Is(0.5Δt1), and Is(2.5Δt1) are fluorescence intensities, which are included in the secondary light corresponding to the irradiation time of primary light 220 with an irradiation intensity Ip(1), and correspond to third information, first information, and second information, respectively. Δt1 represents time (seconds) during which the sample 900i is irradiated with the primary light 220 in the first information acquisition step S100. In the first exemplary embodiment, the common period Δt1 is set in steps S100, S140, and S200. τ represents a relaxation time constant in the process of fluorescence photobleaching of the resin contained in the sample 900i that is irradiated with the primary light 220 with an irradiation intensity Ip(1) for the irradiation time.

In Equation (3), Is(0) represents an unknown fluorescence intensity Is(0) corresponding to the non-irradiation state immediately before the irradiation of the primary light 220, and is target information for analysis of the analysis method 1000 according to the first exemplary embodiment. Is(0) represents a virtual fluorescence intensity when the sample 900i is not irradiated with the primary light 220 in the first information acquisition step S100. In other words, Is(0) represents the fluorescence intensity predicted to be observed under irradiation conditions in which the product of the irradiation density of the primary light 220 and the irradiation time is approximate to “0”.

In the first information acquisition step S100, the fluorescence intensity Is(0.5Δt1) is acquired as illustrated in FIG. 4. As represented by Equation (3), the fluorescence intensity Is(0.5Δt1) is described using a degradation function described using the time constant T for fluorescence photobleaching determined by irradiation conditions for the primary light 220 and the fluorescence intensity Is(0) when the primary light 220 is not irradiated yet, and a representative time when the fluorescence is acquired during the period of steps S100 and S200.

$$Is ( 0.5 Δ t 1 ) = Is ( 0 ) \times exp ( - 0 \text{.5} Δ t 1 / τ ) \qquad ( 3 )$$

Equation (3) is transformed to obtain Equation (4) in which the time constant T is eliminated.

$$Is ( 0 ) = Is ( 0.5 Δ t 1 ) \times exp ( 0 \text{.5} Δ t 1 / τ ) = Is ( 0.5 Δ t 1 ) \times {( Is ( 0.5 Δ t 1 ) / Is ( 2.5 Δt1 ) )}^{⋀} 0 \text{.5} \qquad ( 4 )$$

Similarly, the fluorescence intensity Is(2.5Δt1) is acquired as illustrated in FIG. 4 in the second information acquisition step S200. As represented by Equation (5), the fluorescence intensity Is(2.5Δt1) is described using the degradation function described using the time constant T for fluorescence photobleaching determined by irradiation conditions for the primary light 220 and the fluorescence intensity Is(0) when the primary light 220 is not irradiated yet, and a representative time when the fluorescence is acquired during the period of steps S100 and S200.

$$Is ( 2.5 Δ t 1 ) = Is ( 0 ) \times exp ( - 1.5 Δ t 1 / τ ) \qquad ( 5 )$$

Equation (5) is transformed to obtain Equation (6) in which the time constant T is eliminated.

$$\begin{matrix}Is ( 0 ) = Is ( 2.5 Δ t 1 ) \times exp ( 1.5 Δ t 1 / τ ) \\ = Is ( 2.5 Δ t 1 ) \times ( Is ( 0.5 Δ t 1 ) / Is ( 2. 5 Δ t 1 ) ) \hat{} 1.5\end{matrix} \qquad ( 6 )$$

Equation (4) and Equation (6) are transformed to obtain Equation (7). In step S300, Is(0) corresponding to the third information concerning the degradation of resins that are not affected by photobleaching by the primary light 220 is acquired from the first information (Is(0.5Δt1)) and second information (Is(2.5Δt1) based on the following Equation (7).

$$Is ( 0 ) = ( Is ( 0.5 Δ t 1 ) ) \hat{} 1.5 \times Is ( 2.5 Δ t 1 ) ) \hat{} ( - 0.5 ) \qquad ( 7 )$$

Similarly, in step S400, τ corresponding to fourth information concerning effects of photobleaching due to effects of photobleaching by the primary light 220 is acquired from the first information (Is(0.5Δt1)) and the second information (Is(2.5Δt1)) based on the following Equation (8).

$$τ = Δ t 1 / In ( Is ( 0.5 Δ t 1 ) / Is ( 2.5 Δ t 1 ) ) \qquad ( 8 )$$

Is(0) corresponding to the third information concerning the degradation of resins from which effects of photobleaching are separated and the fourth information (attenuation time constant τ) concerning photobleaching by the primary light 220 are described using known parameters as observable conditions or measurement conditions.

### (Identification Apparatus)

Next, a configuration of the identification apparatus 1100 configured to execute the analysis method 1000 according to the first exemplary embodiment will be described in detail with reference to FIGS. 2A and 2B.

### (Spectral Information Acquisition Unit)

The identification apparatus 1100 includes the spectral information acquisition unit 100 that acquires spectral information about light collected from the sample 900i. The spectral information acquisition unit 100 is a unit that acquires information including a Raman shift corresponding to the difference between the wavenumber of Raman scattered light included in secondary light from the sample 900i and the wavenumber of excitation light included in primary light from the sample 900i, the intensity of spectral components corresponding to the Raman shift, and the intensity of fluorescence components.

### (Light Collecting Unit)

As illustrated in FIGS. 2A and 2B, the spectral information acquisition unit 100 includes a first optical system 76-1 and a second optical system 76-2 to acquire spectral information included in the secondary light at different times time t0 and t1(>t0). The first optical system 76-1 includes a first irradiation portion 22-1 and a first light collecting portion 20-1. The second optical system 76-2 includes a second irradiation portion 22-2 and a second light collecting portion 20-2, and is located downstream of the first optical system 76-1 in a conveyance direction dc. The first irradiation portion 22-1 and the second irradiation portion 22-2 are optically coupled to a first light source 25-1 and a second light source 25-2, respectively. The first light source 25-1 and the second light source 25-2 each include a laser light source. The first optical system 76-1 is a unit that emits the primary light as first light and collects the secondary light. Accordingly, the first optical system 76-1 may otherwise be referred to as the first light collecting unit 76-1. Similarly, the second optical system 76-2 may otherwise be referred to as the second light collecting unit 76-2.

In the identification apparatus 1100, the first optical system 76-1 and the second optical system 76-2 are located at different positions, respectively, in the conveyance direction dc. However, the functions of each unit and constituent optical elements in the first optical system 76-1 are the same as the functions of each unit and constituent optical elements in the second optical system 76-2. To facilitate understanding, branch numbers (−1, −2) corresponding to the two units, respectively, may be omitted in the following description.

FIG. 2B schematically illustrates a configuration example of the spectral information acquisition unit 100. The spectral information acquisition unit 100 includes a light collecting unit 27 including the irradiation portions 22 (22-1, 22-2) for irradiating the sample 900i with light, and the light collecting portions 20 (20-1, 20-2) for collecting Raman scattered light from the sample 900i. Each irradiation portion 22 and each light collecting portion 20 are coaxially arranged on the sample side (object side) as viewed from a dichroic mirror 250. Even when an irradiation surface of the sample 900i has a difference in height or an inclination, a positional deviation between the center of an irradiation spot and the center of a light flux of collected scattered light is less likely to occur.

### (Irradiation Portions)

As illustrated in FIG. 2A, the irradiation portions 22 (22-1, 22-2) are arranged above a conveyance unit 200 at a predetermined working distance WD from a conveyance surface 2005 of the conveyance unit 200.

The irradiation portions 22 (22-1, 22-2) are arranged to focus irradiation light 220 (220-1, 220-2) onto an upper surface of the sample 900i, thereby increasing the scattering intensity of small Raman scattered light that is several digits weaker than Rayleigh scattered light. A unit including the irradiation portion 22 and the light source 25 may otherwise be referred to as an irradiation optical system. An objective lens 260 is located above the conveyance surface 200S at the working distance WD from the conveyance surface 200S in consideration of the thickness of the sample 900i and an object-side focal length FO.

As illustrated in FIG. 2B, the irradiation portion 22 includes the objective lens 260, the dichroic mirror 250, a collimator lens 230, a cylindrical lens, and a reflecting mirror 210. A convex lens, a collimator lens, a concave lens, a zoom lens, or the like is employed as the objective lens 260.

Synthetic silica can be used as a glass material for the collimator lens 230, a cylindrical lens 240, the objective lens 260, and the like. Use of lenses made of synthetic silica as a glass material for these lenses makes it possible to reduce background components including fluorescence and Raman scattered light derived from the glass material.

The objective lens 260 acts as a focusing lens that focuses light from the laser light source 25 on the sample 900i in the irradiation portion 22. The objective lens 260 forms a focal plane 65 that corresponds to a numerical aperture NA and is located at a position apart from the objective lens 260 by the focal length FO, a focal point (focal spot) with a focal point diameter (p (not illustrated), and a focal depth ΔDF.

The collimator lens 230 and the cylindrical lens 240 reduce spreading of emitted light from the laser light source 25 and shape the light into parallel rays. Any other collimating optical element such as an anamorphic prism pair may be used as the cylindrical lens 240. A wavelength filter such as a laser line filter may be located at a position corresponding to a pupil surface of the irradiation portion 22. With this configuration, wavelength characteristics of light irradiated on the sample 900i by the irradiation portion 22 can be improved.

As illustrated in FIG. 2B, at least a part of the irradiation portion 22 can be shared with the light collecting portion 20. Since the light collecting portion 20 and the irradiation portion 22 according to the first exemplary embodiments are coaxially arranged, the objective lens 260 and the dichroic mirror 250 are shared by the light collecting portion 20 and the irradiation portion 22.

### (Light Sources)

The light sources 25 (25-1, 25-2) are light sources for irradiating the sample 900i with the primary light 220 via an optical fiber 130 and the irradiation portions 22. In other words, each light source 25 is optically coupled to the corresponding irradiation portion 22 through the optical fiber 130. As the light source 25, a laser light source having a center wavelength in a wavelength band of 400 nm to 1200 nm is employed. The excitation efficiency of Raman scattered light components increases as the wavelength of irradiation light decreases, and the fluorescence components functioning as background components are reduced as the wavelength increases.

The light sources 25 and the irradiation optical system are adjusted so that the illuminance of the primary light 220 irradiated on the sample in the first information acquisition step S100 is 100j/m² or more.

It may be desirable to select a wavelength at which the difference between the Raman shift of an intended target material and the Raman shift of non-target materials can be clearly obtained as the excitation wavelength of the laser light source applied as the light source 25. At least one of wavelengths of 532 nm, 633 nm, 780 nm, and 1064 nm may be used. While the present exemplary embodiment illustrates an example where a semiconductor laser is used as the light source 25 in the irradiation portion 22, the light source 25 is not limited to this example. Any other laser light source such as a semiconductor excitation solid laser and a gas laser can be used.

### (Light Collecting Portions)

The light collecting portions 20 (20-1, 20-2) are arranged above the conveyance surface 200S so that the secondary light from the upper surface of the sample 900i conveyed by the conveyance unit 200 can be collected.

Each light collecting portion 20 includes the objective lens 260, the dichroic mirror 250, an imaging lens 270, and an optical fiber 190. Like the irradiation portion 22, the objective lens 260 of the light collecting portion 20 includes a convex lens, a collimator lens, a concave lens, and a zoom lens. The light collecting portion 20 may include a wavelength filter such as a band-pass filter or a long-pass filter to reduce excitation light components included in the primary light so that unwanted light can be reduced in the spectral measurement.

To ensure the sufficient light collection efficiency, the light collecting portion 20 uses an objective lens having a large numerical aperture. To ensure the sufficient working distance WD and focal depth, the light collecting 20 uses an objective lens having a small numerical aperture. A numerical aperture of 0.1 to 0.5 is used as the numerical aperture of the objective lens of the light collecting portion 20.

### (Spectral Image Acquisition Unit)

As illustrated in FIG. 2B, the spectral image acquisition unit 10 includes a branching unit 195, the imaging lens 110, a band-pass filter 120, a spectroscopic unit 150, and the imaging unit 170, which are provided in this order from the side of the light collecting portion 20. The spectroscopic unit 150 is arranged so that light collected by the light collecting portion 20 can be dispersed via an imaging lens 160 and a continuous spectrum can be projected on the imaging unit 170 along a row direction or a column direction of an array of light-receiving elements of the imaging unit 170.

In the first exemplary embodiment, as illustrated in FIGS. 2A and 2B, an optical spectrum 280 is projected on the imaging unit 170 along light-receiving elements 350 arranged in a row direction 172r, so that a one-dimensional optical spectrum image 280i is acquired by the imaging unit 170.

To project a spectral image on an effective imaging region on the imaging unit 170 with an improved use efficiency, a grating period and a center wavelength of the spectroscopic unit 150 may be optimized as appropriate in accordance with the wavenumber band of projection. In this case, the imaging unit 170 is located at an optimum position in consideration of an emission angle from the spectroscopic unit 150 and a diffraction efficiency, a wavenumber resolution, and the like of the spectroscopic unit 150.

### (Imaging Unit)

An imaging device, such as a charge-coupled device (CCD) or complementary metal-oxide-silicon (CMOS) imaging device, including a two-dimensional array of light-receiving elements, is used as the imaging unit 170. The plurality of light-receiving elements 350 in the imaging unit 170 according to the first exemplary embodiment is arranged in a matrix. In the case of a delta arrangement or the like, the row direction and the column direction are associated with the directions of two of the three axes, or are associated with the direction of one of the three axes and a combined direction of the other two axes.

In this case, the identification apparatus 1100 identifies properties of the sample 900i while the conveyance unit 200 conveys the sample 900i, and the discrimination apparatus 300 to be described below discriminates the sample 900i depending on the identification result. To improve the throughput of separation processing by the identification apparatus 1100, it may be desirable to increase a conveyance speed vc of the conveyance unit 200. The optical spectrum 280 is projected on the imaging unit 170 while the sample 900i being conveyed lies within the region of irradiation with the irradiation light 220 (focused light 220) from the irradiation portion 22. For example, if the conveyance speed vc by the conveyance unit 200 is 2 m/sec and the length of the sample 900i in the conveyance direction dc is 10 mm, the time during which the imaging unit 170 can detect the spectral image formed by Raman scattered light generated from the sample 900i is 5 milliseconds or less. Accordingly, the imaging unit 170 may desirably have a high frame rate. An example of the imaging unit 170 having a high frame rate is a CMOS image sensor. Therefore, the imaging unit 170 may be desirably a CMOS image sensor.

As described above, the intensity of the Raman scattered light generated from the sample 900i is extremely low, and thus the intensity of the light incident on each of the light receiving elements 350 of the imaging unit 170 is also extremely low. Accordingly, an image sensor having high sensitivity in the wavenumber region where a spectral image corresponding to the optical spectrum 280 is acquired may be desirably used as the imaging unit 170. Rolling shutter image sensors generally have a simple pixel structure and a high aperture ratio and can include large photoelectric conversion elements as compared with global shutter image sensors, and thus can be enhanced in sensitivity and dynamic range. Since the pixel structure is simple, rolling shutter image sensors also have an advantage of low cost compared to global shutter image sensors. For such reasons, in the first exemplary embodiment, a rolling shutter CMOS image sensor is used as the imaging unit 170.

A rolling reset image sensor that performs a sequential reset operation on each row where the light-receiving elements 350 are arranged can be employed as the imaging unit 170. With this configuration, an exposure time for each row where the light-receiving elements 350 are arranged can be increased as much as possible, so that the sensitivity can be increased.

The imaging unit 170 according to the first exemplary embodiment includes a crop read function for performing readout operations on specific rows in a light receiving unit 171 in which the light-receiving elements 350 are two-dimensionally arranged in the row direction 172r and a column direction 172c. This function makes it possible to perform readout operations on specific rows in the light-receiving unit 171 corresponding to the light collecting portion 20.

The imaging unit 170 includes a readout circuit 173, a horizontal scanning circuit 174, a vertical scanning circuit 175, and an output circuit 176, and sequentially reads out signals from a plurality of pixels arranged in a matrix row by row. The vertical scanning circuit 175 selects and drives a certain row in the light-receiving unit 171. The readout circuit 173 reads out the signals output from the pixels in the row selected by the vertical scanning circuit 175, and transfers the signals to the output circuit 176 under the control of the horizontal scanning circuit 174.

Thus, readout operations are performed in a main-scanning direction (row direction). Further, the rows to be selected by the vertical scanning circuit 175 are shifted, and the readout circuit 173 performs readout operations in the main-scanning direction under the control of the horizontal scanning circuit 174. This processing is repeatedly performed while the rows to be selected are shifted in a sub-scanning direction (column direction), thereby making it possible to read out the signals from the entire light-receiving unit 171. The read signals are output to the acquisition unit 30, which is located outside the imaging unit 170, as output signals via an output terminal 177 of the output circuit 176. In this case, scanning in the main-scanning direction is performed at high speed. Scanning in the sub-scanning direction is slower than scanning in the main-scanning direction.

The imaging lens 110 converts branched light transmitted via one of the optical fiber 190 from the light collecting portion 20 and the optical fiber 190 from the branching unit 195 into parallel rays. The optical fiber 190 may otherwise be referred to as the branch light guide portion 190. The band-pass filter 120 attenuates excitation light components included in the received light and transmits some of Raman scattered light components. The band-pass filter 120 has a spectral transmission characteristic of attenuating Raman scattered light at both higher and lower wavenumbers. The spectroscopic unit 150 disperses the received light into wavelength components in a fan-like fashion. The imaging lens 160 projects the light dispersed by the spectroscopic unit 150 on the imaging unit 170. The spectroscopic unit 150 is a transmissive diffraction grating. A reflective diffraction grating of Roland arrangement or Czerny-Turner system can be employed as the diffraction grating. The spectroscopic unit 150 may otherwise be referred to as the diffraction grating 150. The spectral information acquisition unit 100 including the imaging unit 170 acquires spectral information Si about the sample 900i.

### (Acquisition Unit)

The acquisition unit 30 acquires third information concerning the degradation for each sample 900i based on the spectral information Si acquired from the spectral information acquisition unit 100, and acquires identification information Di that identifies whether the sample 900i is a target sample that can be reused or a non-target sample in which degradation has proceeded. The acquisition unit 30 outputs the acquired identification information Di to the command unit 40. The acquisition unit 30 acquires the identification information Di based on at least one of the spectral information Si.

A sample discrimination operation to be performed by the identification apparatus 1100 based on the identification information Di acquired from the acquisition unit 30 will be described below.

### (Control Unit)

The identification apparatus 1100 includes a control unit 400 including the command unit 40 that controls the discrimination operation to be performed by the discrimination apparatus 300 based on third information concerning the degradation acquired from each sample 900i, and a display unit 140 that provides a graphical user interface (GUI) with which a user can designate control conditions. The control unit 400 further includes a first storage unit 60 for storing properties of each sample 900i, and a second storage unit 80 for storing control conditions for the discrimination operation. The command unit 40 includes a display control unit (not illustrated) that displays the optical spectrum 280i acquired from the spectral information acquisition unit 100 via the acquisition unit 30 on the display unit 140.

### (Storage Unit)

The identification apparatus 1100 according to the first exemplary embodiment includes the first storage unit 60, the second storage unit 80, and a third storage unit 90 into/from which data related to the identification operation, the discrimination operation, and the acquisition of spectral information can be stored and called. The first storage unit 60, the second storage unit 80, and the third storage unit 90 may be integrated with each other, may be divided, or may be provided on a remote server to enable remote access.

The first storage unit 60 is configured to store the identification information Di, material information Mi, and the spectral information Si about each sample 900i, and a time tp indicating time when the sample 900i passes through an irradiation area of the primary light 220 in association with each other. The time tp may otherwise be referred to as timing tp.

The second storage unit 80 is configured to store control conditions corresponding to the identification information Di for each sample 900i so as to control the intensity Is of the discrimination operation to be performed by the discrimination apparatus 300. Possible formats of the control conditions include a table that can be referred to, algebraic general expressions, and machine-learned statistic information.

### (Command Unit)

The command unit 40 estimates a processing region passage time at which each sample 900i passes through the region where the discrimination apparatus 300 performs discrimination processing on the sample 900i in accordance with the material and size of the sample 900i based on the identification information Di acquired from the acquisition unit 30, and generates a command to control the discrimination operation of the discrimination apparatus 300. The processing region passage time of the sample 900i can be estimated based on at least one of a signal from the spectral information acquisition unit 100 and a signal from a sample sensor (not illustrated) provided on the conveyance unit 200.

### (Discrimination Apparatus)

As illustrated in FIGS. 2A, 3A, and 3B, the discrimination apparatus 300 includes a flap gate 330 that opens and closes at a predetermined angular speed, and a discrimination control unit 350 for controlling an actuator (not illustrated) to operate the flap gate 330. The discrimination apparatus 300 sorts the samples 900i into a target collection basket 600 or a non-target collection basket 640 based on a control command from the command unit 40. Specifically, the discrimination apparatus 300 performs the discrimination operation based on third information concerning the degradation of resins of the sample 900i, including the fluorescence intensity Is(0), from which effects of fluorescence photobleaching are separated.

In the discrimination apparatus 300, the flap gate 330 can be replaced with an air nozzle 330 for discharging compressed air for a predetermined discharge time at a predetermined discharge speed and a predetermined discharge flow rate.

### (Conveyance Unit)

The conveyance unit 200 is a conveyance unit that conveys a plurality of samples 900i (i=1, 2, . . . ) sequentially supplied from a feeder 500 in the conveyance direction dc (x-direction in FIG. 2A) at the predetermined conveyance speed vc. The conveyance unit 200 and the feeder 500 constitute a conveyance unit that conveys each sample 900i.

The conveyance unit 200 according to the first exemplary embodiment includes a conveyor belt that conveys each sample 900i supplied from the feeder 500 in the conveyance direction dc at the speed vc, and linearly conveys each sample 900i on the conveyance surface 200S. As a modified example, the conveyance unit 200 can be replaced with a turntable feeder that conveys each sample 900i spirally outward, a vibrating feeder including a vibrator for causing each sample 900i to move in a predetermined direction, a conveyor roller including a plurality of rollers, and the like.

In the first exemplary embodiment, if a conveyor belt is used, 0.1 to 5 m/s can be applied as the conveyance speed vc of the conveyance unit 200.

### (Material Information Reference Unit)

The spectral information acquisition unit 100 includes a material information reference unit 180 that acquires material information about the sample 900i based on the spectral information Si acquired by the spectral image acquisition unit 10. The material information reference unit 180 acquires the material information Mi included in the sample 900i. The spectral information acquisition unit 100 stores at least one of the spectral information Si and the material information Mi in the first storage unit 60 through the command unit 40 to be described below.

A material database for the material information reference unit 180 to refer to may be a database stored in a local server included in the identification apparatus 1100, or may be a remote server accessible via the Internet or an intranet.

As described above, the spectral information acquisition unit 100 is configured to acquire the material information Mi included in the sample 900i.

### Second Exemplary Embodiment

An analysis method 2000 according to a second exemplary embodiment will be described with reference to FIGS. 4 to 6B and Table 2.

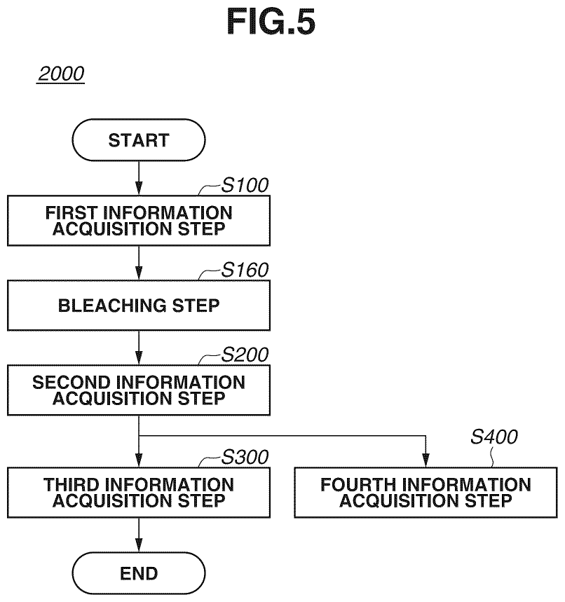

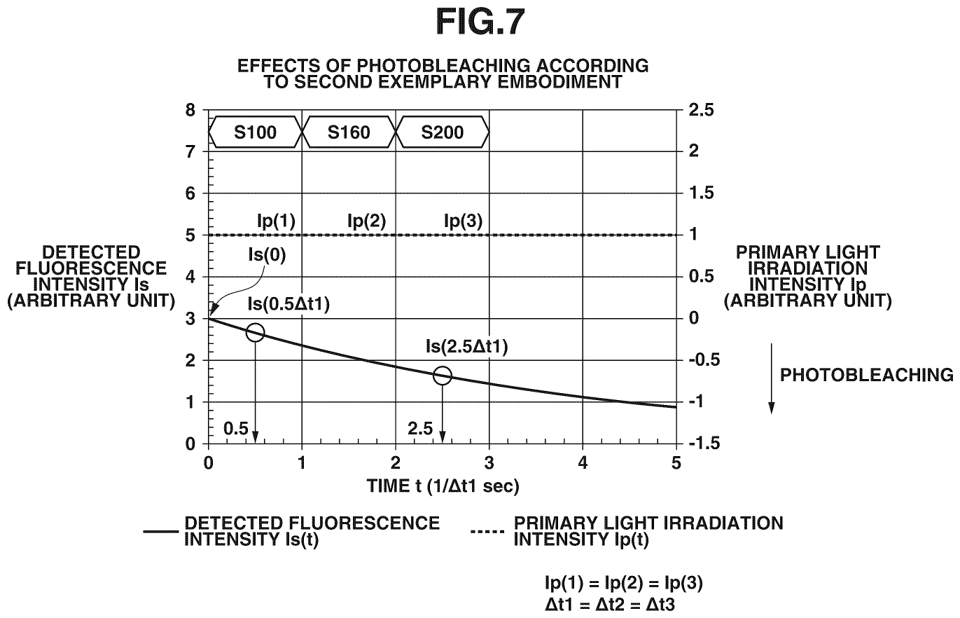

FIG. 5 is a flowchart illustrating steps of the analysis method 2000 according to the second exemplary embodiment and the order of steps. FIG. 7 is a graph of the irradiation intensity Ip(t) of primary light and the detected intensity Is(t) of fluorescence components over time in each step according to the second exemplary embodiment.

Table 2 illustrates a list of relationships between the bleaching attenuation ratio and primary light irradiation conditions in the first information acquisition step S100 and the second information acquisition step S200 of the analysis method 2000 according to the second exemplary embodiment.

As illustrated in FIG. 5, the analysis method 2000 differs from the analysis method 1000 in that the blanking step S120 is omitted and a bleaching step S160 is performed during a period after the first information acquisition step S100 and before the second information acquisition step S200.

Specifically, in the first exemplary embodiment, the period Δt1 between time t of Δt1 to 2Δt1 is the blanking period corresponding to Ip(2)=0 in which the irradiation of the primary light 220 is not performed. The second exemplary embodiment differs from the first exemplary embodiment in that during the period Δt1 between time t of Δt1 to 2Δt1, the irradiation of the primary light 220 is performed with the same irradiation intensity and irradiation wavelength as those of the primary light 220 irradiated in the first information acquisition step S100.

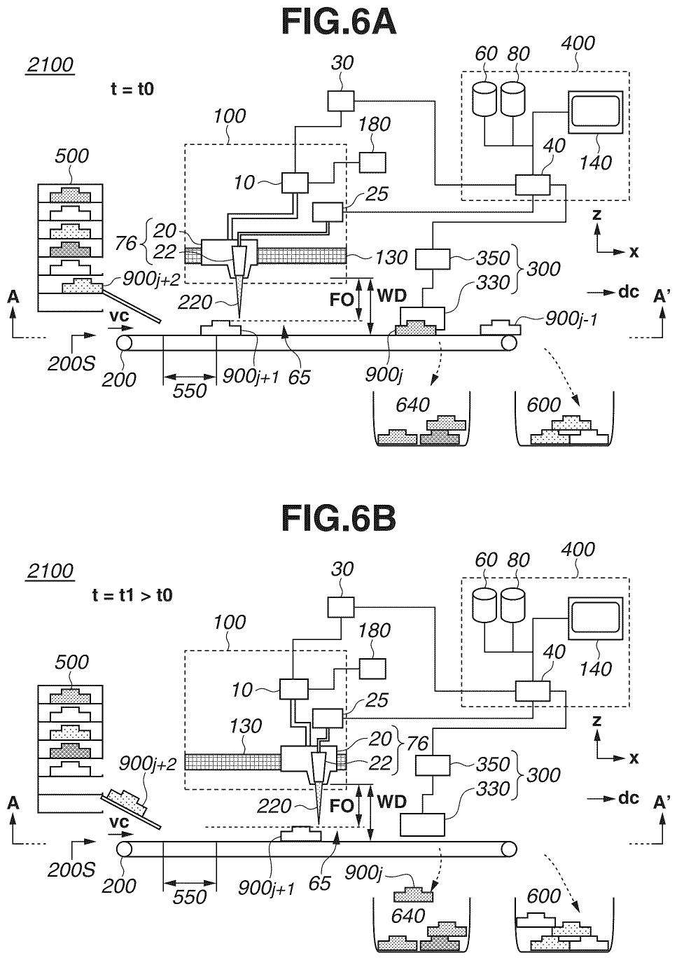

The analysis method 2000 can be executed using an identification apparatus 2100 illustrated in FIGS. 6A and 6B. The identification apparatus 2100 differs from the identification apparatus 1100 in that a linear stage 130 that causes the optical systems 76 to move at a speed in synchronization with the samples 900i (i=1, 2, . . . ) conveyed at the conveyance speed vc in the conveyance direction dc on the conveyance belt of the conveyance unit 200. Further, the identification apparatus 2100 differs from the identification apparatus 1100 in that only one pair of optical systems 76 including the irradiation portion 22 and the light collecting portion 20 is provided on a conveyance path. A plane taken along A-A′ in FIGS. 6A and 6B corresponds to the plane taken along A-A′ in FIG. 2A.

The identification apparatus 2100 causes the optical systems 76 to move in the conveyance direction while irradiating the sample 900i with the primary light 220 in synchronization with the conveyance of the sample 900i during a period after time t of at least 3Δt1 elapses from 0.

As illustrated in FIG. 6A, the identification apparatus 2100 collects the secondary light from the sample 900i during the period in which the time of Δt1 elapses from 0, performs spectral identification processing, acquires the fluorescence intensity Is(0.5Δt1) corresponding to the first information, and executes step S100. FIG. 6A illustrates an operation of the identification apparatus 2100 during a period of 0≤time t0<Δt1.

Next, the identification apparatus 2100 executes the bleaching step S160 while causing the optical systems 76 to move in synchronization with the movement of the sample 900i without performing spectral identification processing on the secondary light collected from the sample 900i during the period in which time t of further Δt1 elapses from Δt1.

Next, as illustrated in FIG. 6B, the identification apparatus 2100 collects the secondary light from the sample 900i and performs spectral identification processing during the period in which time t of Δt1 further elapses from 2Δt1, acquires fluorescence intensity Is(2.5Δt1) corresponding to the second information, and executes step S200. FIG. 6B illustrates an operation of the identification apparatus 2100 during a period of 2Δt1≤time t1<3Δt1.

As illustrated in Table 2 and FIGS. 5 and 7, the analysis method 2000 irradiates the primary light 220 under the common irradiation condition Ip(1) between the first information acquisition step S100 and the second information acquisition step S200, and the bleaching step S160 in which spectral information about the secondary light is not acquired is performed between step S100 and S200. In the case of using the identification apparatus 2100 according to the second exemplary embodiment, after completion of step S200 on the sample 900i, a recovery operation for causing the optical systems 76 to be recovered to the upstream side on the conveyance path is performed using the linear stage 130 to execute step S100 on a sample 900i+1.

In the bleaching step S160, the sample 900i is irradiated with the irradiation light 220 under the same irradiation conditions as those for the primary light in steps S100 and S200. Further, the bleaching step S160 is executed so that the samples 900i (i=1, 2, . . . ) are each irradiated with the primary light 220 under the same irradiation conditions in the first information acquisition step S100, the bleaching step S160, and the second information acquisition step S200 in succession.

In the analysis method 2000 including the bleaching step S160, as illustrated in Table 2 and FIG. 7, the bleaching attenuation ratio D included in the second information Is(2.5Δt1) is represented as exp(−2.5Δt1/τ), which is greater than the bleaching attenuation ratio D of exp(−1.5Δt1/r) according to the first exemplary embodiment. As compared with the analysis method 1000 according to the first exemplary embodiment, the analysis method 2000 according to the second exemplary embodiment enables more accurate calculation of the third information concerning photobleaching by the primary light 220 during measurement. Accordingly, the analysis method 2000 according to the second exemplary embodiment makes it possible to more accurately acquire information concerning the degradation of resins from which effects of photobleaching due to the measurement are separated as compared with the first exemplary embodiment.

TABLE 2

| | | Change of | |
|---|---|---|---|
| | | Fluorescence | |
| | Primary | Intensity | Optically- |
| | Light | over Time | Acquired |
| | Irradiation | in Each Step | Bleaching |
| Step | Intensity | Fluorescence | Attenuation |
| Time | Ip(t) | Intensity Is(t) | Ratio D |
| S100 | Ip(1) | Is(0) × exp(−t/τ) | exp(−0.5Δt1/τ) |
| 0 ≤ t < Δt1 | | | |
| S160 | Ip(1) | Is(0) × exp(−t/τ) | 0 |
| Δt1 ≤ t < 2Δt1 | | | |
| S200 | Ip(1) | Is(0) × exp(−t/τ) | exp(−2.5Δt1/τ) |
| 2Δt1 ≤ t < 3Δt1 | | | |

The fluorescence intensity Is(0.5Δt1) is acquired in the first information acquisition step S100 of the analysis method 2000 according to the second exemplary embodiment. The fluorescence intensity Is(0.5Δt1) is calculated by General Expression (9) described using the time constant T for photobleaching, the virtual fluorescence intensity Is(0) corresponding to the degradation of resins when the primary light 220 is not irradiated yet, and the representative time for acquiring the fluorescence spectrum in step S100. The time constant T for photobleaching is determined by the irradiation conditions for the primary light 220.

In Equation (9), Is(0), Is(0.5Δt1), Is(2.5Δt1), Δt1, and τ are the same parameters as those used in the first exemplary embodiment.

$$Is ( 0.5 Δ t 1 ) = Is ( 0 ) \times exp ( - 0 \text{.5} Δ t 1 / τ ) \qquad ( 9 )$$

Equation (9) is transformed to obtain Equation (10) in which the time constant T is eliminated.

$$\begin{matrix}Is ( 0 ) = Is ( 0.5 Δ t 1 ) \times exp ( 0.5 Δ t 1 / τ ) \\ = Is ( 0.5 Δ t 1 ) \times ( Is ( 0.5 Δ t 1 ) / Is ( 2. 5 Δ t 1 ) ) \hat{} 0.25\end{matrix} \qquad ( 10 )$$

Similarly, Is(2.5Δt1) represented by Equation (11) is acquired in the second information acquisition step S200 of the analysis method 2000 according to the second exemplary embodiment.

$$Is ( 2.5 Δ t 1 ) = Is ( 0 ) \times exp ( - 2 \text{.5} Δ t 1 / τ ) \qquad ( 11 )$$

Equation (11) is transformed to obtain Equation (12) in which the time constant T is eliminated.

$$\begin{matrix}Is ( 0 ) = Is ( 2.5 Δ t 1 ) \times exp ( 2.5 Δ t 1 / τ \\ = Is ( 2.5 Δ t 1 ) \times ( Is ( 0.5 Δ t 1 ) / Is ( 2. 5 Δ t 1 ) ) \hat{} 1.25\end{matrix} \qquad ( 12 )$$

Equation (10) and Equation (12) are transformed to obtain Equation (13).

In step S300, based on the following Equation (13), Is(0) corresponding to the third information concerning the degradation of resins that are not affected by photobleaching by the primary light 220 is acquired from the first information (Is(0.5Δt1)) and the second information (Is(2.5Δt1)).

$$Is ( 0 ) = ( Is ( 0.5 Δ t 1 ) ) \hat{} 1.25 \times ( Is ( 2.5 Δ t 1 ) ) \hat{} ( - 0.25 ) \qquad ( 13 )$$

Similarly, in step S400, based on the following Equation (14), T corresponding to the fourth information concerning effects of photobleaching by the primary light 220 is algebraically acquired from the first information (Is(0.5Δt1)) and the second information (Is(2.5Δt1)).

$$τ = 2 Δ t 1 / In ( Is ( 0 \text{.5} Δ t 1 ) / Is ( 2.5 Δ t 1 ) ) \qquad ( 14 )$$

Is(0) corresponding to the third information concerning the degradation of resins from which effects of photobleaching are separated and the fourth information (attenuation time constant τ) concerning photobleaching by the primary light 220 are described using known parameters as observable conditions or measurement conditions.

In other words, as illustrated in FIGS. 5 and 7, also in the analysis method 2000 including the bleaching step S160, Is(0) corresponding to the third information concerning the degradation of resins from which effects of photobleaching are separated can be acquired, like in the analysis method 1000 according to the first exemplary embodiment.

### Modification of Second Exemplary Embodiment

A configuration of an apparatus that includes a static optical system 76 and the conveyance unit 200 and is configured to suspend a conveyance operation at a time when the irradiation area of the primary light 220 from the optical system 76 overlaps an analysis target region of the sample 900i is a modification (not illustrated) of the identification apparatus 2100. An identification apparatus according to the modification (not illustrated) is configured to perform a series of steps S100, S160, and S200, like the identification apparatus 2100. The identification apparatus according to the modification need not necessarily include the conveyance unit 200 and the linear stage 130 that synchronizes the movement of the optical systems 76 in the conveyance direction.

The static optical system 76 may otherwise be referred to as the stationary optical system 76 because the static optical system 76 is placed in a stationary state on an installation surface where the identification apparatus is installed. The analysis target region may otherwise be referred to as a region of interest (ROI).

### Third Exemplary Embodiment

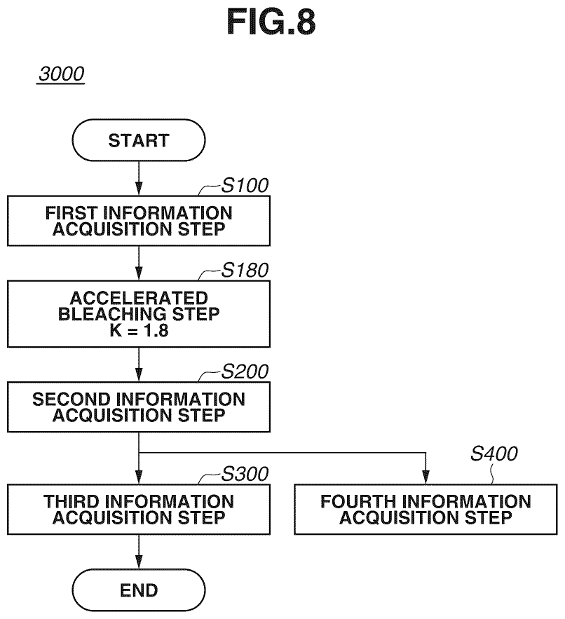

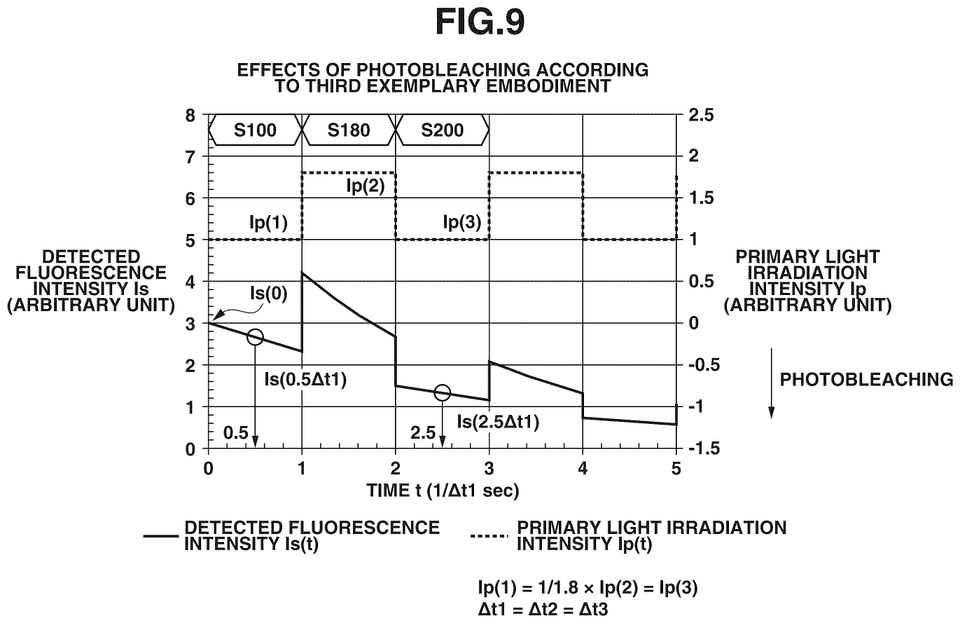

An analysis method 3000 according to a third exemplary embodiment will be described with reference to FIGS. 8 and 9.

FIG. 8 is a flowchart illustrating steps of the analysis method 3000 according to the third exemplary embodiment and the order of steps. FIG. 9 is a graph of the irradiation intensity Ip(t) of primary light and the detected intensity Is(t) of fluorescence components over time in each step according to the third exemplary embodiment.

The analysis method 3000 according to the third exemplary embodiment differs from the analysis method 2000 according to the second exemplary embodiment in that an accelerated bleaching step S180 in which only the irradiation intensity of the primary light 220 is increased by 1.8 times is performed instead of the bleaching step 160. The analysis method 3000 is applicable to the identification apparatus 2100 to which the analysis method 2000 is applicable and to a modification of the identification apparatus 2100.

The irradiation intensity of the primary light 220 in the accelerated bleaching step S180 according to the third exemplary embodiment is 1.8 times the irradiation intensity of the primary light 220 in the bleaching step S160 according to the second exemplary embodiment, which corresponds to applying an acceleration condition in which the time constant for photobleaching is increased by 1/1.8 times≈0.556 times. In other words, the illuminance of the primary light 220 on the sample 900i in the accelerated bleaching step S180 according to the third exemplary embodiment is 1.8 times the illuminance of the primary light 220 on the sample 900i in the bleaching step S160 according to the second exemplary embodiment. The irradiation intensity of the primary light 220 in the accelerated bleaching step S180 according to the third exemplary embodiment is 1.8 times the irradiation intensity of the primary light 220 in the bleaching step S160 according to the second exemplary embodiment, which corresponds to applying an acceleration condition in which the intensity of fluorescence components included in the secondary light is increased by 1.8 times. As the irradiation wavelength of the primary light 220 in the accelerated bleaching step S180 according to the third exemplary embodiment, the same irradiation wavelength as the irradiation wavelength of the primary light 220 in each of the bleaching step S160 according to the second exemplary embodiment and steps S100 and S200 according to the third exemplary embodiment is used.

Table 3 illustrates a list of relationships between the bleaching attenuation ratio D and irradiation conditions for the primary light in the first information acquisition step S100 and the second information acquisition step S200 of the analysis method 3000 according to the third exemplary embodiment.

As illustrated in Table 3 and FIG. 9, in the analysis method 3000 including the accelerated bleaching step S180, the bleaching attenuation ratio D included in the second information Is(2.5Δt1) is represented as exp(−3.3 Δt1/τ), which is greater than the bleaching attenuation ratio D of exp(−2.5Δt1/τ) according to the second exemplary embodiment.

As compared with the analysis method 1000 according to the first exemplary embodiment and the analysis method 2000 according to the second exemplary embodiment, the analysis method 3000 according to the third exemplary embodiment enables more accurate calculation of the third information concerning photobleaching by the primary light 220 during measurement. Accordingly, the analysis method 2000 according to the third exemplary embodiment makes it possible to more accurately acquire information about the degradation of resins from which effects of photobleaching due to the measurement are separated as compared with the first and second exemplary embodiments.

TABLE 3

| | | Change of | |
|---|---|---|---|
| | | Fluorescence | |
| | Primary | Intensity | Optically- |
| | Light | over Time | Acquired |
| | Irradiation | in Each Step | Bleaching |
| Step | Intensity | Fluorescence | Attenuation |
| Time | Ip(t) | Intensity Is(t) | Ratio D |
| S100 | Ip(1) | Is(0) × exp(−t/τ) | exp(−0.5Δt1/τ) |
| 0 ≤ t < Δt1 | | | |
| S180 | Ip(1) × 1.8 | Is(0) × exp(−Δt1/τ) × | 0 |
| Δt1 < t < 2Δt1 | | 1.8 × exp(−(t−Δt1/ | |
| | | (τ/1.8)) | |
| S200 | Ip(1) | Is(0) × exp(−Δt1/τ) × | exp(−3.3Δt1/τ) |
| 2Δt1 ≤ t < 3Δt1 | | exp(−Δt1/(τ/1.8)) × | |
| | | exp(−(t−2Δt1/τ) | |

The fluorescence intensity Is(0.5Δt1) is acquired in the first information acquisition step S100 of the analysis method 3000 according to the third exemplary embodiment. The fluorescence intensity Is(0.5Δt1) is calculated by General Expression (15) described using the time constant T for photobleaching, the virtual fluorescence intensity Is(0) corresponding to the degradation of resins when the primary light 220 is not irradiated yet, and the representative time 0.5Δt1 for acquiring the fluorescence during the period in which step S100 is executed.

In Equation (15), Is(0), Is(0.5Δt1), Is(2.5Δt1), Δt1, and τ are the same parameters as those used in the first exemplary embodiment and the second exemplary embodiment.

$$Is ( 0.5 Δ t 1 ) = Is ( 0 ) \times exp ( - 0 \text{.5} Δ t 1 / τ ) \qquad ( 15 )$$

Equation (15) is transformed to obtain Equation (16) in which the time constant T is eliminated.

$$\begin{matrix}Is ( 0 ) = Is ( 0.5 Δ t 1 ) \times exp ( 0.5 Δ t 1 / τ ) \\ = Is ( 0.5 Δ t 1 ) \times ( Is ( 0.5 Δ t 1 ) / Is ( 2. 5 Δ t 1 ) ) \hat{} ( 1 / 5.6 )\end{matrix} \qquad ( 16 )$$

Similarly, Is(2.5Δt1) represented by Equation (17) is acquired in the second information acquisition step S200 of the analysis method 2000 according to the third exemplary embodiment.

$$Is ( 2 \text{.5} Δ t 1 ) = Is ( 0 ) \times exp ( - 3.3 Δ t 1 / τ ) \qquad ( 17 )$$

Equation (17) is transformed to obtain Equation (18) in which the time constant T is eliminated.

$$\begin{matrix}Is ( 0 ) = Is ( 2.5 Δ t 1 ) \times exp ( 3.3 Δ t 1 / τ ) \\ = Is ( 2.5 Δ t 1 ) \times ( Is ( 0.5 Δ t 1 ) / Is ( 2. 5 Δ t 1 ) ) \hat{} ( 6.6 / 5.6 )\end{matrix} \qquad ( 18 )$$

Equation (16) and Equation (18) are transformed to obtain Equation (19).

$$Is ( 0 ) = Is ( 0.5 Δ t 1 ) ) \hat{} ( 6.6 / 5.6 ) \times ( Is ( 2.5 Δ t 1 ) ) \hat{} ( - 1 / 5. 6 ) \qquad ( 19 )$$

Similarly, in step S400, based on the following Equation (20), τ corresponding to the fourth information concerning effects of fluorescence photobleaching due to effects of photobleaching by the primary light 220 is acquired from the first information (Is(0.5Δt1)) and the second information (Is(2.5Δt1)).

$$τ = 2.8 Δ t 1 / In ( Is ( 0.5 Δ t 1 ) / Is ( 2.5 Δ t 1 ) ) \qquad ( 20 )$$

Is(0) corresponding to the third information concerning the degradation of resins from which effects of photobleaching are separated and the fourth information (attenuation time constant τ) concerning photobleaching by the primary light 220 are described using known parameters as observable conditions or measurement conditions.

In other words, also in the analysis method 3000 including the accelerated bleaching step S180, as illustrated in FIGS. 8 and 9, Is(0) corresponding to the third information concerning the degradation of resins from which effects of photobleaching are separated can be acquired, like in the analysis method 1000 and the analysis method 2000.

### Fourth Exemplary Embodiment

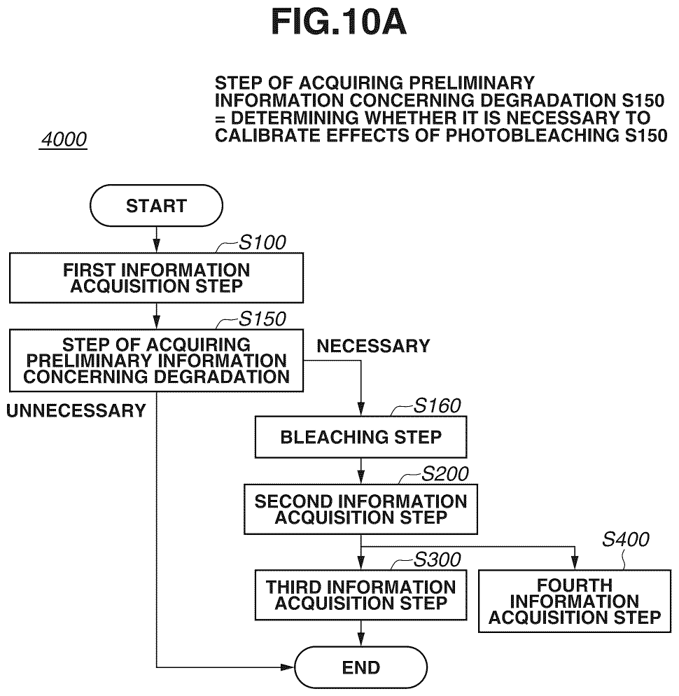

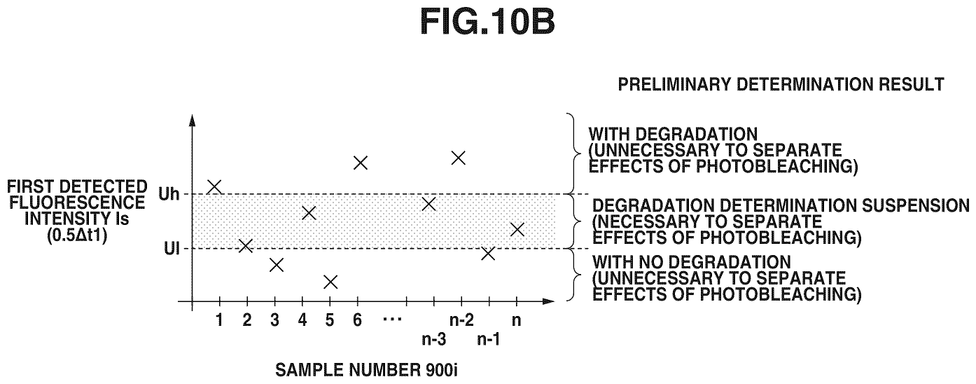

An analysis method 4000 according to a fourth exemplary embodiment will be described with reference to FIGS. 10A and 10B.

FIG. 10A is a flowchart illustrating steps of the analysis method 400 according to the fourth exemplary embodiment and the order of steps. FIG. 10B illustrates an example of determining a plurality of samples 900i in step S150 of acquiring preliminary information concerning the degradation included in the analysis method 4000.

The analysis method 4000 differs from the analysis method 2000 according to the second exemplary embodiment in that the analysis method 4000 includes step S150 of acquiring preliminary information concerning the degradation of the sample 900i.

In step S150 of acquiring preliminary information concerning the degradation of the sample 900i, it is determined whether it is necessary to perform processing for calibrating effects of photobleaching using the fluorescence intensity Is(0.5Δt1) corresponding to the first information acquired in the first information acquisition step S100. Accordingly, step S150 of acquiring preliminary information concerning the degradation of the sample 900i can also be referred to as step S150 of determining whether it is necessary to calibrate effects of photobleaching. In other words, the preliminary information to be acquired in step S150 is information concerning determination as to whether it is necessary to perform processing for calibrating effects of photobleaching.

FIG. 10B is a scatter diagram illustrating the fluorescence intensity Is(0.5Δt1) corresponding to the first information acquired for each sample 900i. It is obvious that the fluorescence intensity Is(0.5Δt1) is dispersed by the effects of photobleaching due to the degradation of each sample 900i and the measurement.

In the fourth exemplary embodiment, the processing proceeds to step S300 from step S150 to acquire the third information, assuming that the optical density of functional groups generated as a result of split of a resin skeleton due to the degradation before the spectral measurement without separating effects of photobleaching is sufficiently high and degradation has proceeded. The deemed degradation sample group is extracted as a sample group with a fluorescence intensity higher than a suspension determination upper limit Uh of the fluorescence intensity Is(0.5Δt1) corresponding to the first information.

Similarly, the processing proceeds to step S300 from step S150 to acquire the third information, assuming that the optical density of functional groups generated as a result of split of a resin skeleton due to the degradation before the spectral measurement without separating effects of photobleaching is sufficiently low and degradation has not proceeded. The deemed non-degradation sample group is extracted as a sample group with a fluorescence intensity lower than a suspension determination lower limit UI of the fluorescence intensity Is(0.5Δt1) corresponding to the first information.

On the other hand, the first information is not sufficient to make clear that the functional groups correspond to the optical density of functional groups generated as a result of split of the resin skeleton due to the degradation before the spectral measurement, or that the functional groups are affected by fluorescence photobleaching, so that a suspension determination is made to determine that it is necessary to separate effects of fluorescence photobleaching. Since it is necessary to separate effects of fluorescence photobleaching on the sample 900i on which the suspension determination is made, the processing proceeds to step S200 from step S150 through step S160 to acquire the third information instep S300 based on the acquired first information and second information. Such a suspension determination sample group is extracted as a sample group having the fluorescence intensity Is(0.5Δt1) corresponding to the first information that is higher than the suspension determination lower limit UI and is lower than the suspension determination upper limit Uh.

According to the fourth exemplary embodiment, it is possible to reduce the operation rate of each of the light source 25, the spectral element 550, and the imaging unit 170. Further, the reduction in running cost and the improvement in the operation rate of the entire analysis apparatus in consideration of a system failure can be enhanced as compared with the other exemplary embodiments.

While the analysis method 4000 is illustrated as a modification of the analysis method 2000, the analysis methods 1000 and 3000 can also be modified into an analysis method including step S150 of acquiring preliminary information concerning the degradation of the sample 900i.

The present invention is not limited to the above-described exemplary embodiments. Various modifications and changes can be made without departing from the spirit and scope of the present invention. Accordingly, the following claims are attached to publicize the scope of the present invention.

1. An analysis method for acquiring information about degradation of a sample including a resin using information concerning an optical density of a functional group contained in the resin, the analysis method comprising:
acquiring first information concerning the optical density of the functional group based on a first fluorescence spectrum measured by irradiating a predetermined region of the sample with first light;
acquiring second information concerning the optical density based on a second fluorescence spectrum measured by irradiating at least a part of the predetermined region with second light after the irradiation of the first light; and
acquiring third information concerning degradation of the sample based on the first information and the second information.

2. The analysis method according to claim 1, wherein the third information includes information concerning degradation of the sample immediately before the sample is subjected to photobleaching by the first light and the second light.

3. The analysis method according to claim 1, further comprising acquiring fourth information concerning photobleaching of the functional group based on the first information and the second information.

4. The analysis method according to claim 1, wherein irradiation conditions for the second light are same as irradiation conditions for the first light with respect to an irradiation wavelength.

5. The analysis method according to claim 4, wherein the irradiation conditions are same as the irradiation conditions for the first light with respect to an irradiation intensity.

6. The analysis method according to claim 1, further comprising causing bleaching by irradiating at least a part of the predetermined region with third light after the irradiation of the first light and before the irradiation of the second light.

7. The analysis method according to claim 1, wherein irradiation conditions for the third light are same as irradiation conditions for the first light with respect to an irradiation wavelength.

8. The analysis method according to claim 7, wherein the irradiation conditions are same as the irradiation conditions for the first light with respect to the irradiation intensity.

9. The analysis method according to claim 1, further comprising acquiring preliminary information concerning the degradation to determine whether to execute the acquisition of the second information based on the first information.

10. The analysis method according to claim 1, wherein the first light and the second light have a center wavelength in a wavelength band of 400 nm to 1200 nm.

11. The analysis method according to claim 1, wherein the sample is irradiated with the first light at an illuminance of 100 j/m² or more.

12. The analysis method according to claim 1, wherein the first information is acquired by acquiring scattered light from the sample in a wavelength band of 1800 cm⁻¹ to 2700 cm⁻¹.

13. The analysis method according to claim 1, wherein the resin includes one of polypropylene (PP), polyethylene (PE), polycarbonate (PC), and polystyrene (PS).

14. The analysis method according to claim 1, wherein the sample including at least a resin in which degradation proceeds with a structural change in which the functional group is generated due to split of a main skeleton of the resin is a target of the analysis.
